(19) United States
(12) Patent Application Publication
(10) Pub. No.: US 2021/0093930 A1
(43) Pub. Date: Apr. 1, 2021

(54) PVC Ball with Multi-Layer Structure and Device for Manufacturing PVC Ball

(71) Applicant: Chu Zhou Heng jia Sports Products Limited, Chuzhou City (CN)

(72) Inventor: Shaofeng Shi, Chuzhou City (CN)

(21) Appl. No.: 16/994,007

(22) Filed: Aug. 14, 2020

(30) Foreign Application Priority Data
Sep. 30, 2019 (CN) 2019109436841

(51) Int. Cl. A63B 41/10; B29C 41/06; B29C 41/22

(52) U.S. Cl. CPC A63B 41/10; B29C 41/06; B29K 2027/06; A63B 2209/00; B29C 41/22

(57) ABSTRACT

A PVC ball with a multi-layer structure, wherein the ball skin layer of the PVC ball is used as the outer ball skin, and the second PVC ball skin layer is used as the inner ball skin. The inner wall of the first PVC ball skin layer is fused with the outer wall of the second PVC ball skin layer; an air nozzle is inserted and connected to an inflation nozzle structure of the first PVC ball skin layer and the second PVC ball skin layer. The upper mold and the lower mold of the device are provided with closed mold fasteners for controlling opening and closing. One end of the rotation shaft is connected to the lower mold, the other end of the rotation shaft is rotatably connected to the mold frame, and one end of the revolution shaft is rotatably connected to the mold frame.

### CROSS REFERENCE TO RELATED APPLICATION

This application takes the benefit of and claims priority to Chinese Patent Application Ser. No. 2019109436841 filed on Sep. 30, 2019, the contents of which are herein incorporated by reference.

### BACKGROUND OF THE INVENTION

### Field of the Invention

The utility model relates to the technical field of a PVC ball. Specifically, the utility model relates to a PVC ball with a multi-layer structure and a device for manufacturing the PVC ball.

### Description of the Related Art

At present, all the PVC balls manufactured by the slush molding and rotational molding processes have a single-layer structure. The process of processing a PVC ball with a multi-layer structure is relatively complicated and the cost is high. Therefore, it is particularly important to solve this type of problem.

### SUMMARY OF THE INVENTION

The purpose of the utility model is to design a PVC ball with a multi-layer structure and the device for manufacturing a PVC ball. The obtained PVC ball has the function of a double-layer PVC ball.

The utility model is realized by the following technical solution.

The utility model provides a PVC ball with a multi-layer structure, comprising a first PVC ball skin layer, a second PVC ball skin layer and an air nozzle, wherein the first PVC ball skin layer is used as an outer ball skin, the second PVC ball skin layer is used as an inner ball skin, and the inner wall of the first PVC ball skin layer is fused to the outer wall of the second PVC ball skin layer;

the air nozzle is inserted and connected to an inflation nozzle structure of the first PVC ball skin layer and the second PVC ball skin layer.

When the above arrangement structure is adopted, the PVC ball with a multi-layer structure can obtain the functionality of a double-layer PVC ball, and different properties can be obtained by selecting the characteristics of different ball skin layers. For example, a high-strength and strong-supporting PVC formula material is used as an inner ball skin, and the outer ball skin is made of soft and comfortable PVC formula material, so that the ball has good support and the surface of the ball has a soft and comfortable touch. At the same time, the foaming formula material with an explosion-proof function is also used as the inner ball skin, while the outer ball skin is made of non-foamed and smooth surface material. This can solve the defect that the ball with the smooth ball skin surface does not have the explosion-proof function and it is extremely easy to smudge the surface cells of the ball with the explosion-proof function due to being foamed. Therefore, the PVC ball with a multi-layer structure can integrate the ball skins of two characteristics, which not only realizes that the original explosion-proof function of the ball is significantly improved when the ball skin of the outer smooth surface is added, but also realizes that the surface of the ball has the function of being smooth, beautiful and easy to clean.

Further, in order to better realize the utility model, the following arrangement structure is particularly adopted: the first PVC ball skin layer is a non-foamed PVC ball skin layer, and the second PVC ball skin layer is a foamed explosion-proof PVC ball skin layer.

Further, in order to better realize the utility model, the following arrangement structure is particularly adopted: the surface roughness of the first PVC ball skin layer is less than the surface roughness of the second PVC ball skin layer.

When the above arrangement structure is adopted, the surface of the non-foamed first PVC ball skin layer is smoother than the surface of the foamed second PVC ball skin layer. The foaming formula material with an explosion-proof function is used as the inner ball skin, while the outer ball skin is made of non-foamed and smooth surface material. This can solve the defect that the ball with the smooth ball skin surface does not have the explosion-proof function and it is extremely easy to smudge the surface cells of the ball with the explosion-proof function due to being foamed. The utility model integrates the ball skins of two characteristics, which not only realizes that the original explosion-proof function of the ball is significantly improved when the ball skin of the outer smooth surface is added, but also realizes that the surface of the ball has the function of being smooth, beautiful and easy to clean.

Further, in order to better realize the utility model, the following arrangement structure is particularly adopted: the structural strength of the first PVC ball skin layer is less than the structural strength of the second PVC ball skin layer.

When the above arrangement structure is adopted, a high-strength and strong-supporting PVC formula material is used as an inner ball skin, and the outer ball skin is made of soft and comfortable PVC formula material, so that the ball has good support and the surface of the ball has a soft and comfortable touch.

Further, in order to better realize the utility model, the following arrangement structure is particularly adopted: the thickness of the first PVC ball skin layer is greater than or equal to the thickness of the second PVC ball skin layer.

Further, in order to better realize the utility model, the following arrangement structure is particularly adopted: the thickness of the turning part at the inflation nozzle structure of the second PVC ball skin layer is greater than the thickness of the remaining parts of the second PVC ball skin layer.

When the above arrangement structure is adopted, the structural rigidity of the turning part at the inflation nozzle structure can be improved.

The utility model further discloses a device for manufacturing a PVC ball with a multi-layer structure. The device for manufacturing a PVC ball with a multi-layer structure is used for manufacturing the PVC ball with a multi-layer structure described above. The device for manufacturing a PVC ball with multi-layer structure comprises a mold rolling turntable, a rotational molding oven, a mold, a rotation shaft, a mold frame, and a revolution shaft, wherein the mold comprises an upper mold and a lower mold, the upper mold and the lower mold are provided with closed mold fasteners for controlling opening and closing; the mold is capable of being placed in the rotational molding oven, the mold rolling turntable is rotatably installed inside the rotational molding oven, the mold rolling turntable is used to install the mold, the rotation shaft is a hollow shaft, one end of which is connected to the rotational molding oven and is communicated with the interior of the rotational molding oven; the mold frame is a hollow frame, the mold frame is communicated with the rotation shaft, the other end of the rotation shaft is rotatably connected to the mold frame, one end of the revolution shaft is rotatably connected to the mold frame, the axis of the rotation shaft is provided in non-parallel to the axis of the revolution shaft; the upper mold is provided with a secondary injection structure to form a through secondary injection port.

Further, in order to better realize the utility model, the following arrangement structure is particularly adopted: the secondary injection port is correspondingly provided at the inflation nozzle structure of the PVC ball with the multilayer structure.

Further, in order to better realize the utility model, the following arrangement structure is particularly adopted: the axis of the rotation axis and the axis of the revolution axis are perpendicular to each other.

Further, in order to better realize the utility model, the following arrangement structure is particularly adopted: the rotation shaft is rotatably connected to the mold frame by a slewing bearing, and the revolution shaft is rotatably connected to the mold frame by a slewing bearing.

The utility model has the following advantages and beneficial effects.

In the utility model, the PVC ball with a multi-layer structure can obtain the functionality of a double-layer PVC ball, and different properties can be obtained by selecting the characteristics of different ball skin layers. For example, a high-strength and strong-supporting PVC formula material is used as an inner ball skin, and the outer ball skin is made of soft and comfortable PVC formula material, so that the ball has good support and the surface of the ball has a soft and comfortable touch. At the same time, the foaming formula material with an explosion-proof function is also used as the inner ball skin, while the outer ball skin is made of non-foamed and smooth surface material. This can solve the defect that the ball with the smooth ball skin surface does not have the explosion-proof function and it is extremely easy to smudge the surface cells of the ball with the explosion-proof function due to being foamed. Therefore, the PVC ball with a multi-layer structure can integrate the ball skins of two characteristics, which not only realizes that the original explosion-proof function of the ball is significantly improved when the ball skin of the outer smooth surface is added, but also realizes that the surface of the ball has the function of being smooth, beautiful and easy to clean.

### BRIEF DESCRIPTION OF THE DRAWINGS

In order to explain the embodiments of the utility model or the technical solutions in the prior art more clearly, the drawings required in the embodiments or the description of the prior art will be briefly introduced. Obviously, the drawings in the following description are only some of the embodiments of the utility model. For those skilled in the art, other drawings can also be obtained based on these drawings without paying any creative labor.

FIG. 1 is a schematic diagram of a structure of a PVC ball with a multi-layer structure;

FIG. 2 is a schematic diagram of a structure of a device for manufacturing a PVC ball with a multi-layer structure (in which no mold is installed);

FIG. 3 is a schematic diagram of a structure of a device for manufacturing a PVC ball with a multi-layer structure (in which a mold is installed);

FIG. 4 is a schematic diagram of a structure of a mold.

The reference numbers in the figures are as follows:

1. a first PVC ball skin layer; 2. a second PVC ball skin layer; 3. an air nozzle; 4. an upper mold; 5. a lower mold; 6. a rotation shaft; 7. a mold frame; 8. a revolution shaft; 9. a secondary injection port; 10. a mold rolling turntable; 11. a rotational molding oven.

### DETAILED DESCRIPTION OF THE SEVERAL EMBODIMENTS

In order to make the purpose, technical solution and advantage of the utility model clearer, the technical solution of the utility model will be described in detail below. Obviously, the described embodiments are only some of the embodiments of the utility model, rather than all the embodiments. Based on the embodiments of the utility model, all other embodiments obtained by those skilled in the art without paying any creative labor fall within the scope of protection of the utility model.

### Embodiment 1

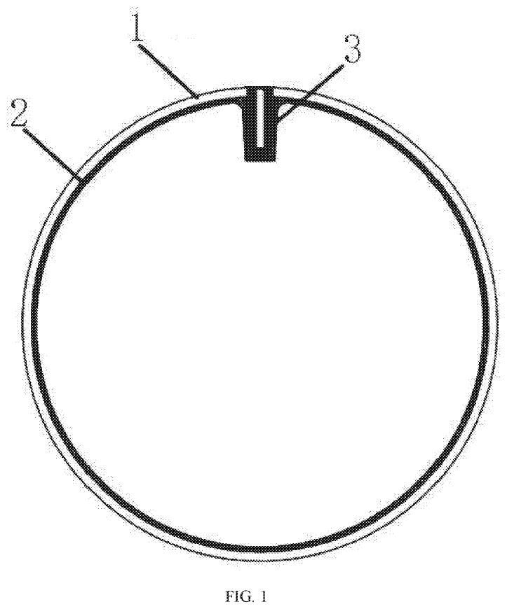

A PVC ball with a multi-layer structure is provided. The obtained PVC ball has the functionality of a double-layer PVC ball, as shown in FIG. 1, and is specifically configured into the following structure.

Basically, the PVC ball with a multi-layer structure comprises a first PVC ball skin layer 1, a second PVC ball skin layer 2 and an air nozzle 3. The first PVC ball skin layer 1 is used as an outer ball skin. The second PVC ball skin layer 2 is used as an inner ball skin. The first PVC ball skin layer 1 encloses the second PVC ball skin layer 2 therein. The inner wall of the first PVC ball skin layer 1 is fused to the outer wall of the second PVC ball skin layer 2. An inflation nozzle structure for installing the air nozzle 3 runs through and is formed at the corresponding part of the first PVC ball skin layer 1 and the second PVC ball skin layer 2. An air nozzle 3 is inserted at the inflation nozzle structure. The air nozzle 3 is fixedly connected to the inflation nozzle structure of the first PVC ball skin layer 1 and the second PVC ball skin layer 2 through the frictional force generated by the compression.

In this embodiment, the thickness of the first PVC ball skin layer 1 is greater than or equal to the thickness of the second PVC ball skin layer 2. Preferably, the thickness of the turning part at the inflation nozzle structure of the second PVC ball skin layer 2 is greater than the thickness of the remaining parts of the second PVC ball skin layer 2 to improve the structural rigidity of the turning part at the inflation nozzle structure.

Specifically, in order to obtain certain properties, the first PVC ball skin layer 1 is a non-foamed PVC ball skin layer, the second PVC ball skin layer 2 is a foamed explosion-proof PVC ball skin layer, at the same time, the surface roughness of the first PVC ball skin layer 1 is less than the surface roughness of the second PVC ball skin layer 2, and the structural strength of the first PVC ball skin layer 1 is less than the structural strength of the second PVC ball skin layer 2.

The surface of the non-foamed first PVC ball skin layer 1 is smoother than the surface of the foamed second PVC ball skin layer 2. The foaming formula material with an explosion-proof function is used as the inner ball skin, while the outer ball skin is made of non-foamed and smooth surface material. This can solve the defect that the ball with the smooth ball skin surface does not have the explosion-proof function and it is extremely easy to smudge the surface cells of the ball with the explosion-proof function due to being foamed. A high-strength and strong-supporting PVC formula material is used as an inner ball skin, and the outer ball skin is made of soft and comfortable PVC formula material, so that the ball has good support and the surface of the ball has a soft and comfortable touch. The utility model integrates the ball skins of two characteristics, which not only realizes that the original explosion-proof function of the ball is significantly improved when the ball skin of the outer smooth surface is added, but also realizes that the surface of the ball has the function of being smooth, beautiful and easy to clean.

### Embodiment 2

This embodiment provides a method for manufacturing a PVC ball with a multilayer structure in Embodiment 1, which specifically comprises three methods.

The first method comprises the following steps:

Step 1: preparing the slurry of the soft and comfortable outer ball skin, wherein the slurry of the outer ball skin has the following formula: 45% parts of PVC resins, 50% parts of plasticizers, 3% parts of additives, the remaining part as coloring pigments;

Step 2: preparing the slurry of the high-strength and strong-supporting inner ball skin, wherein the slurry of the inner ball skin has the following formula: 45% parts of PVC resins, 45% parts of plasticizers, 3% parts of additives, the remaining part as coloring pigments;

Step 3: injecting the prepared slurry of the outer ball skin into the slush molding or rotational molding mold and covering the mold locking screw, pushing the mold into a slush molding or rotational molding heating furnace body, heating and plasticizing the mold in the furnace body for 4 minutes, then pulling the mold out of the furnace body and re-injecting the slurry of the inner ball skin from the secondary injection part of the mold with a slurry conveying gun, then closing the secondary injection part tightly, pushing the mold into the heating furnace body again, and heating the mold for 7 minutes to plasticize the slurry in the mold;

Step 4: pulling the mold out of the heating furnace body, putting the mold in water to cool down, then loosening the bolt to open the mold, taking out the ball, and carrying out inflatable shaping.

The PVC ball is provided with a two-layer structure.

The second method comprises the following steps.

A method for manufacturing a PVC ball with a multi-layer structure comprises the following steps:

Step 1: preparing the slurry of the soft and comfortable outer ball skin, wherein the slurry of the outer ball skin has the following formula: 40% parts of PVC resins, 40% parts of plasticizers, 2% parts of additives, the remaining part as coloring pigments;

Step 2: preparing the slurry of the high-strength and strong-supporting inner ball skin, wherein the slurry of the inner ball skin has the following formula: 45% parts of PVC resins, 40% parts of plasticizers, 2% parts of additives, the remaining part as coloring pigments;

Step 3: injecting the prepared slurry of the outer ball skin into the slush molding or rotational molding mold and covering the mold locking screw, pushing the mold into a slush molding or rotational molding heating furnace body, heating and plasticizing the mold in the furnace body for 2 minutes, then pulling the mold out of the furnace body and re-injecting the slurry of the inner ball skin from the secondary injection part of the mold with a slurry conveying gun, then closing the secondary injection part tightly, pushing the mold into the heating furnace body again, and heating the mold for 5 minutes to plasticize the slurry in the mold;

Step 4: pulling the mold out of the heating furnace body, putting the mold in water to cool down, then loosening the bolt to open the mold, taking out the ball, and carrying out inflatable shaping.

The PVC ball is provided with a two-layer structure.

The third method comprises the following steps.

A method for manufacturing a PVC ball with a multi-layer structure comprises the following steps:

Step 1: preparing the slurry of the soft and comfortable outer ball skin, wherein the slurry of the outer ball skin has the following formula: 50% parts of PVC resins, 65% parts of plasticizers, 5% parts of additives, the remaining part as coloring pigments;

Step 2: preparing the slurry of the high-strength and strong-supporting inner ball skin, wherein the slurry of the inner ball skin has the following formula: 60% parts of PVC resins, 50% parts of plasticizers, 4% parts of additives, the remaining part as coloring pigments;

Step 3: injecting the prepared slurry of the outer ball skin into the slush molding or rotational molding mold and covering the mold locking screw, pushing the mold into a slush molding or rotational molding heating furnace body, heating and plasticizing the mold in the furnace body for 8 minutes, then pulling the mold out of the furnace body and re-injecting the slurry of the inner ball skin from the secondary injection part of the mold with a slurry conveying gun, then closing the secondary injection part tightly, pushing the mold into the heating furnace body again, and heating the mold for 10 minutes to plasticize the slurry in the mold;

Step 4: pulling the mold out of the heating furnace body, putting the mold in water to cool down, then loosening the bolt to open the mold, taking out the ball, and carrying out inflatable shaping.

A high-strength and strong-supporting PVC formula material is used as an inner ball skin, and the outer ball skin is made of soft and comfortable PVC formula material. A secondary injection structure is provided at the inflation nozzle of the mold or any position of the ball. In the middle of the first injection of the liquid slurry of the outer ball skin of the mold into the mold for heating and molding, the secondary injection port designed on the mold is opened. The liquid slurry of the inner ball skin is re-injected into the mold for over-molding, so that the outer ball skin and the inner ball skin are integrated to achieve the functionality of the double-layer PVC ball. In this way, the ball has good support and the surface of the ball has a soft and comfortable touch.

The foaming formula material with an explosion-proof function is used as the inner ball skin, while the outer ball skin is made of non-foamed and smooth surface material. In the middle of the first injection of the liquid slurry of the outer ball skin of the mold into the mold for heating and molding, the secondary injection port designed on the mold is opened. The liquid slurry of the inner ball skin is re-injected into the mold for over-molding, so that the outer ball skin and the inner ball skin are integrated. This can solve the defect that the ball with the smooth ball skin surface does not have the explosion-proof function and it is extremely easy to smudge the surface cells of the ball with the explosion-proof function due to being foamed. The utility model integrates the ball skins of two characteristics, which not only realizes that the original explosion-proof function of the ball is significantly improved when the ball skin of the outer smooth surface is added, but also realizes that the surface of the ball has the function of being smooth, beautiful and easy to clean.

### Embodiment 3

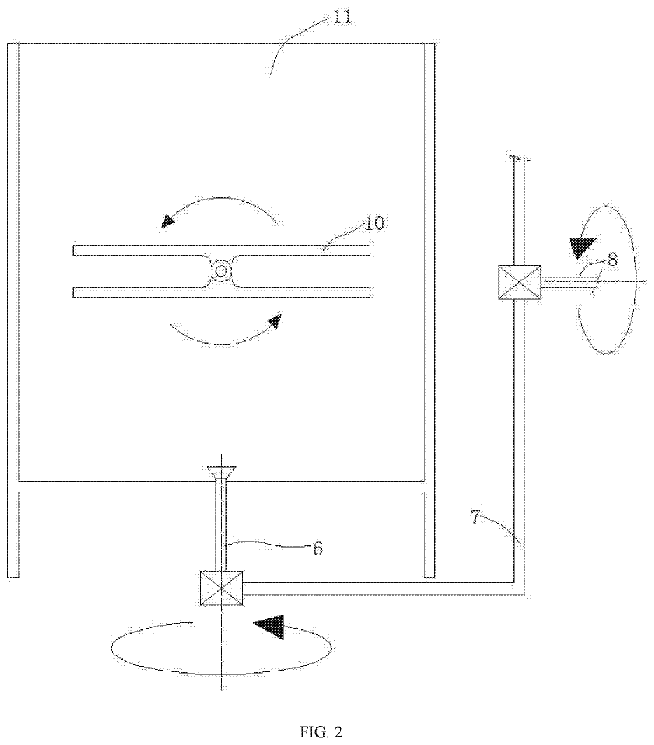

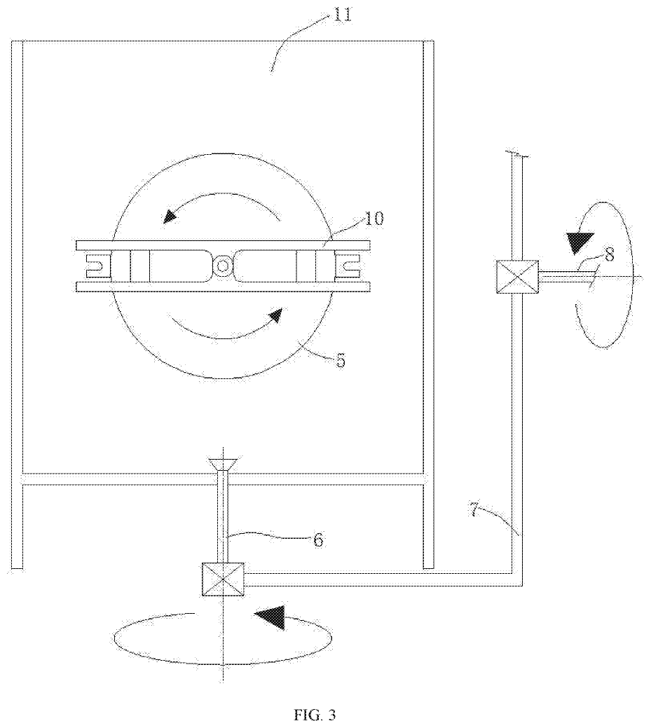

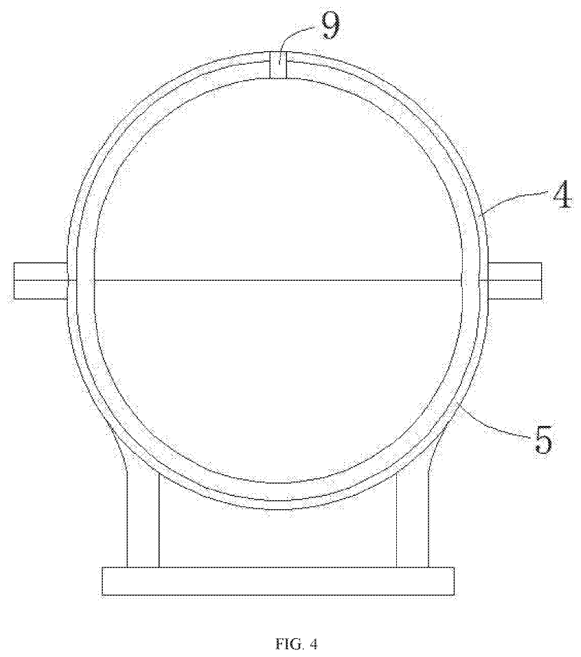

This embodiment provides a device for manufacturing a PVC ball with a multi-layer structure in Embodiment 1 based on the method for manufacturing a PVC ball with a multilayer structure in Embodiment 2, as shown in FIG. 2, FIG. 3 and FIG. 4. The following arrangement structure is adopted in particular.

The device for manufacturing a PVC ball with a multi-layer structure is specifically a rotational molding device, comprising a mold rolling turntable 10, a rotational molding oven 11, a mold, a rotation shaft 6, a mold frame 7, and a revolution shaft 8, wherein the mold comprises an upper mold 4 and a lower mold 5. The mold rolling turntable 10 can install a mold. The rotational molding oven 11 is used to accommodate the mold and heat the mold as a heating furnace body. The top of the rotational molding oven 11 has an opening. The opening at the top is equipped with a furnace cover. The mold rolling turntable 10 is provided inside the rotational molding oven 11. The mold rolling turntable 10 is installed on the inner wall of the rotational molding oven 11 by a slewing bearing. The upper mold 4 and the lower mold 5 are semi-circular molds. The upper mold 4 and the lower mold 5 are provided with closed mold fasteners that can be fastened and opened to each other. The closed mold fasteners can be locking screws. By changing the state of the closed mold fasteners, the opening and closing state of the upper mold 4 and the lower mold 5 are controlled. The top center position of the upper mold 4 is provided with a secondary injection structure. The secondary injection structure forms a through secondary injection port 9, and the secondary injection port 9 is correspondingly provided at the inflation nozzle structure of the PVC ball with the multilayer structure. The axis of the rotation shaft 6 is provided in non-parallel to the axis of the revolution shaft 8. In this embodiment, the axis of the rotation axis 6 and the axis of the revolution axis 8 are perpendicular to each other. The mold frame 7 is roughly an L-shaped hollow frame, comprising a horizontal rod and a vertical rod. The rotation shaft 6 is a vertically arranged hollow shaft. The bottom end of the rotation shaft 6 is rotatably connected to the end of the horizontal rod of the mold frame 7 by a slewing bearing. At the same time, the bottom end of the rotation shaft 6 is also communicated with the end of the horizontal rod of the mold frame 7. The top end of the rotation shaft 6 passes through the center position of the bottom wall of the rotational molding oven 11 and extends into the rotational molding oven 11. The rotation shaft 6 is fixedly connected to the rotational molding oven 11. The revolution shaft 8 is horizontally arranged. The left end of the revolution shaft 8 is rotatably connected to the vertical rod of the mold frame 7 by a slewing bearing. The rotation axis of the mold rolling turntable 10 is arranged horizontally and is perpendicular to the axis of the revolution shaft 8. The mold frame 7 serves as a heat energy pipeline. High-temperature gas can enter the rotational molding furnace 11 through the hollow portion of the mold frame 7 and the hollow portion of the rotation shaft 6 as an energy source for heating the slurry in the mold.

The above is only the specific embodiment of the utility model, but the protection scope of the utility model is not limited thereto. Any changes or replacements, which are conceivable by those skilled in the art within the technical scope disclosed by the utility model, should be covered within the protection scope of the utility model.

What is claimed is:

1. A PVC ball with a multi-layer structure, comprising a first PVC ball skin layer (1), a second PVC ball skin layer (2) and an air nozzle (3), wherein the first PVC ball skin layer (1) is used as an outer ball skin, the second PVC ball skin layer (2) is used as an inner ball skin, and the inner wall of the first PVC ball skin layer (1) is fused to the outer wall of the second PVC ball skin layer (2);
the air nozzle (3) is inserted and connected to an inflation nozzle structure of the first PVC ball skin layer (1) and the second PVC ball skin layer (2).

2. The PVC ball with a multi-layer structure according to claim 1, wherein the first PVC ball skin layer (1) is a non-foamed PVC ball skin layer, and the second PVC ball skin layer (2) is a foamed explosion-proof PVC ball skin layer.

3. The PVC ball with a multi-layer structure according to claim 1, wherein the surface roughness of the first PVC ball skin layer (1) is less than the surface roughness of the second PVC ball skin layer (2).

4. The PVC ball with a multi-layer structure according to claim 3, wherein the structural strength of the first PVC ball skin layer (1) is less than the structural strength of the second PVC ball skin layer (2).

5. The PVC ball with a multilayer structure according to claim 1, wherein the thickness of the first PVC ball skin layer (1) is greater than or equal to the thickness of the second PVC ball skin layer (2).

6. The PVC ball with a multi-layer structure according to claim 1, wherein the thickness of the turning part at the inflation nozzle structure of the second PVC ball skin layer (2) is greater than the thickness of the remaining parts of the second PVC ball skin layer (2).

7. A device for manufacturing a PVC ball with a multi-layer structure, wherein the device for manufacturing a PVC ball with a multi-layer structure is used for manufacturing a PVC ball with a multi-layer structure according to claim 1, wherein the device for manufacturing a PVC ball with multi-layer structure comprises a mold rolling turntable (10), a rotational molding oven (11), a mold, a rotation shaft (6), a mold frame (7), and a revolution shaft (8), wherein the mold comprises an upper mold (4) and a lower mold (5), the upper mold (4) and the lower mold (5) are provided with closed mold fasteners for controlling opening and closing; the mold is capable of being placed in the rotational molding oven (11), the mold rolling turntable (10) is rotatably installed inside the rotational molding oven (11), the mold rolling turntable (10) is used to install the mold, the rotation shaft (6) is a hollow shaft, one end of which is connected to the rotational molding oven (11) and is communicated with the interior of the rotational molding oven (11); the mold frame (7) is a hollow frame, the mold frame (7) is communicated with the rotation shaft (6), the other end of the rotation shaft (6) is rotatably connected to the mold frame (7), one end of the revolution shaft (8) is rotatably connected to the mold frame (7), the axis of the rotation shaft (6) is provided in non-parallel to the axis of the revolution shaft (8); the upper mold (4) is provided with a secondary injection structure to form a through secondary injection port (9).

8. The device for manufacturing a PVC ball with a multilayer structure according to claim 7, wherein the secondary injection port (9) is correspondingly provided at the inflation nozzle structure of the PVC ball with the multilayer structure.

9. The device for manufacturing a PVC ball with a multi-layer structure according to claim 7, wherein the axis of the rotation axis (6) and the axis of the revolution axis (8) are perpendicular to each other.

10. The device for manufacturing a PVC ball with a multi-layer structure according to claim 7, wherein the rotation shaft (6) is rotatably connected to the mold frame (7) by a slewing bearing, and the revolution shaft (8) is rotatably connected to the mold frame (7) by a slewing bearing.
